(19) United States
(12) Patent Application Publication
(10) Pub. No.: US 2010/0313265 A1
(43) Pub. Date: Dec. 9, 2010

(54) Method and Apparatus for Preventing Spoofed Packet Attacks

(75) Inventors: Tao Lin, Beijing City (CN); Yanchang Shen, Beijing City (CN)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Hangzhou H3C Technologies Co., Ltd., Hangzhou (CN)

(21) Appl. No.: 12/765,318

(22) Filed: Apr. 22, 2010

(30) Foreign Application Priority Data
Jun. 9, 2009 (CN) 200910086572.5

(51) Int. Cl. G06F 21/00; G06F 15/16; G06F 15/173

(52) U.S. Cl. 726/22; 709/245; 709/225

(57) ABSTRACT

The present invention discloses a method to prevent spoofed packet attacks, wherein, a DHCPv6 relay agent device forwards address assignment packets between a DHCPv6 client and a DHCPv6 server in stateful configuration mode, establishes and maintains a client information table according to the client information in the address assignment packets, and filters neighbour discovery (ND) packets sent from clients according to the client information table. The present invention also discloses a DHCPv6 relay agent device. The technical proposal of the invention can protect the DHCPv6 relay agent device against spoofed ND packet attacks.

### CROSS-REFERENCE TO RELATED APPLICATIONS

The present application claims priority to Chinese Patent Application CN 200910086572.5 filed in the PRC Patent Office on Jun. 9, 2009, the entire contents of which is incorporated herein by reference.

### BACKGROUND

1. Field of the Invention

This invention relates in general to the field of Internet Protocol version 6 (IPv6) and more particularly to a method and apparatus for preventing spoofed packet attacks.

2. Description of the Related Art

The Dynamic Host Configuration Protocol for IPv6 (DHCPv6) was designed to assign IPv6 addresses and other network configuration parameters for hosts.

DHCPv6 adopts a client-server mode, in which the client sends a configuration request to the DHCPv6 server, and the server returns an IP address and other configuration parameters to the client to implement dynamic configuration.

FIG. 1 is a typical schematic diagram illustrating a network running DHCPv6. A client contacts the DHCPv6 server on the same subnet via the link-scope multicast address to obtain an IPv6 address and other configuration parameters. If the DHCPv6 server resides on another subnet, the DHCPv6 client can contact the server via a DHCPv6 relay agent. Thus, you do not need to deploy a DHCPv6 server on each subnet. This method saves costs and facilitates centralized management.

DHCPv6 provides two address assignment modes, stateful configuration and stateless configuration. In stateful configuration mode, the DHCPv6 server assigns an IPv6 address and other configuration options for the client. In stateless configuration mode, the DHCPv6 server assigns configuration options except an IPv6 address for the client. The technical solution of the present invention relates to the stateful configuration mode, which will be described in the following part.

FIG. 2 is a schematic diagram illustrating how DHCPv6 address assignment packets in stateful configuration mode are exchanged on a network as shown in FIG. 1. FIG. 2 comprises the following steps:

At step 201, the client sends out a solicit message with the destination address of FF02::1:2, which identifies every DHCPv6 relay agent device and DHCPv6 server on the segment. The DHCPv6 relay agent forwards the solicit message to the DHCPv6 server. All subsequent packets between the client and server will be forwarded by the relay agent.

At step 202, the DHCPv6 server receiving the solicit message replies with an Advertise message, which contains the ID and priority of the DHCPv6 server. The client receives all the Advertise messages sent by the servers (if any) within a specified time and selects one DHCPv6 server according to the priority information.

At step 203, the client sends a Request message to the selected DHCPv6 server.

At step 204, when the server receives the Request message, it selects a prefix from the prefix pool and sends it to the client in a reply. The client configures its own IPv6 address with the prefix and parameters with other configuration information.

At step 205, when the specified timer T1 expires, the client sends a Renew message to the server to renew its IP address. Herein, T1 is half the lease of the client IP address.

At step 206, the DHCPv6 server first checks the binding information, fills the Option field and sends back a reply to allow renewing the IP address. The client can sense any change of the option.

At step 207, when T2 expires and the client has not received any reply for the Renew message, it sends a Rebind message to the DHCPv6 server.

At step 208, when receiving the Rebind message from the client, the DHCPv6 server does the same as at step 206.

At step 209, if the option changes, the server initiatively sends a Reconfigure message to tell the client to update its configuration parameters.

At step 210, when receiving the Reconfigure message from the server, the client translates OPTION RECONF MSG of the message. If msg-type is 5, which means the prefix changes, the client sends a Renew message; if msg-type is 11, which means the option changes, the client sends an Information-request message.

At step 211, the DHCPv6 server sends back a reply in response to the client message.

At step 212, if the client no longer uses the IP address, such as going offline, it sends a Release message to the DHCPv6 server.

At step 213, when receiving the Release message, the DHCPv6 server marks the client IP address as idle, and sends back a Reply message.

At step 214, if the client finds that the address obtained by using the prefix got at step 204 has been used by another client through duplicate address detection, it sends a Decline message to the DHCPv6 server to inform the server.

Besides the packet exchange process as shown in FIG. 2, the DHCPv6 stateful configuration mode also provides a rapid address assignment method. That is, the client adds a rapid commit option in the solicit message sent at step 201. When the DHCPv6 server receives the message, it directly sends back a reply. The reply is the same as that sent at step 204 except it carries a rapid commit option. Other procedures are the same as FIG. 2.

The ND protocol is a fundamental component of IPv6. It uses five types of Internet Control Message Protocol version 6 (ICMPv6) packets to implement such functions as address resolution, neighbour reachability detection, duplicate address detection, router/prefix discovery, address autoconfiguration and redirection.

Table 1 shows the five types of ICMPv6 messages and their functions.

TABLE 1

| ICMPv6 | | |
|---|---|---|
| messages | ICMP types | Functions |
| Neighbour | 135 | Obtain the link-layer address of a |
| Solicitation (NS) | | neighbor. |
| | | Detect whether a neighbor is reachable. |
| | | Detect duplicate addresses. |
| Neighbour | 136 | Respond to the NS message. |
| Advertisement | | When a node changes at the link layer, |
| (NA) | | it initiatively sends an NA message to |
| | | its neighbours to notify the change. |
| Router | 133 | Upon start-up, a node sends an RS |
| Solicitation | | message to a router to query prefix and |
| (RS) | | other information for auto- |
| | | configuration. |
| Router | 134 | Respond to the RS message. |
| Advertisement | | If advertising RA messages is not |
| (RA) | | suppressed, a router advertises RA |
| | | messages periodically, which include |
| | | prefix and flag information. |
| Redirect | 137 | When certain conditions are satisfied, |
| | | the default gateway sends a redirect |
| | | message to a source host so that the |
| | | host can get a correct next hop for |
| | | sending subsequent packets. |

In current networks, the DHCPv6 relay agent is deployed on a Layer 3 device and connected to hosts through a Layer 2 switch. The hosts and the DHCPv6 relay agent can directly exchange ND packets. Because the ND packets are transferred in plain text, an attacker can forge ND packets to attack the DHCPv6 relay agent device. For example, spoofed NS messages cause the DHCPv6 relay agent to add too many useless ND entries; spoofed NA messages cause the DHCPv6 relay agent to change ND entries, compromising network security.

To solve the above issues, the current technology adopts static address assignment and SEND solutions. With static address assignment solution, the access switch pre-assigns an IPv6 address for each access host and binds the address with the link address and access point. An access point is a link-layer connector, such as an Ethernet port. The SEND solution encrypts and authenticates the ND packets to ensure security for ND packet exchange. Both routers and hosts are required to support encryption and authentication.

However, the static address assignment solution is not suitable for large-scale IPv6 deployment due to high management costs; the SEND solution requires that the current devices and hosts upgrade their IPv6 protocol stack to support encryption and authentication, but few systems supports this upgrade and thus the SEND solution is not feasible.

Therefore, a new solution should be provided to prevent spoofed packet attacks and ensure the security of the DHCPv6 relay agent device.

### SUMMARY OF THE INVENTION

The present invention provides a method for defending against spoofed packet attacks. The method protects the DHCPv6 relay agent device from being attacked by spoofed ND packets.

The present invention also provides a DHCPv6 relay agent device, which can prevent spoofed ND packet attacks.

To achieve the objectives, the technical proposal of the present invention comprises:

A method for preventing spoofed packet attacks, which is applicable to a network where a DHCPv6 relay agent device resides between the clients and the DHCPv6 server, comprising:

the DHCPv6 relay agent device forwarding address assignment packets between clients and the DHCPv6 server in stateful configuration mode;

the DHCPv6 relay agent device establishing and maintaining a client information table according to the client information in the forwarded packets;

the DHCPv6 relay agent device filtering clients ND packets according to the client information table.

A DHCPv6 relay agent device, which forwards packets between the client and the DHCPv6 server and comprises a forwarding module, a storage module and a filtering module, wherein

the forwarding module is used to forward address assignment packets between the client and the DHCPv6 server in stateful configuration mode, and establish and maintain a client information table according to the client information in the address assignment packets

the storage module is used to store the client information table; and

the filtering module is used to filter clients' ND packets according to the client information table.

In the solutions mentioned above, the DHCPv6 relay agent device of the present invention forwards address assignment packets between a client and a DHCPv6 server in stateful configuration mode, establishes and maintains a client information table according to the client information in the address assignment packets, and filters clients ND packets sent from clients according to the client information table, and thus prevents the attack of spoofed ND packets.

### BRIEF DESCRIPTION OF THE SEVERAL VIEWS OF THE DRAWINGS

FIG. 1 is a schematic diagram illustrating a normal DHCPv6 network.

FIG. 2 is a schematic diagram illustrating the normal exchange process of DHCPv6 address assignment packets.

FIG. 3 is a flow chart illustrating how an embodiment of the present invention prevents spoofed packet attacks.

FIG. 4 is a schematic diagram illustrating client entry state transition in an embodiment of the present invention.

FIG. 5 is the block diagram of the DHCPv6 relay agent device in an embodiment of the present invention.

### DETAILED DESCRIPTION

The idea of the present invention is: when the DHCPv6 relay agent device forwards the address assignment packets between the client and the DHCPv6 server in stateful configuration mode, it records the client information according to the address assignment packets, filters ND packets according to the client information, and thus prevents the attack of spoofed ND packets, malicious occupation of resources, and malfunction of the network.

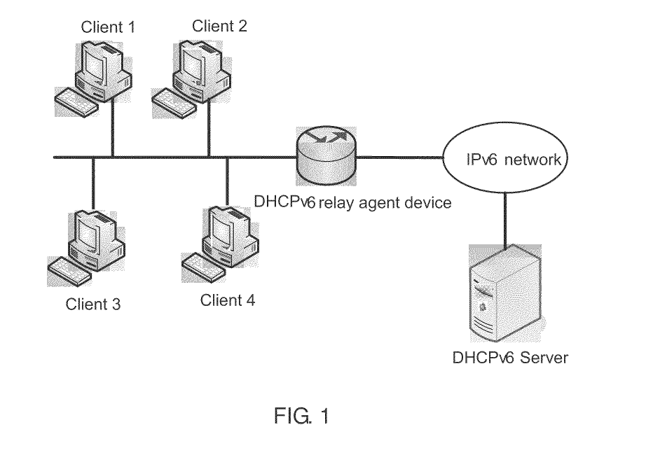

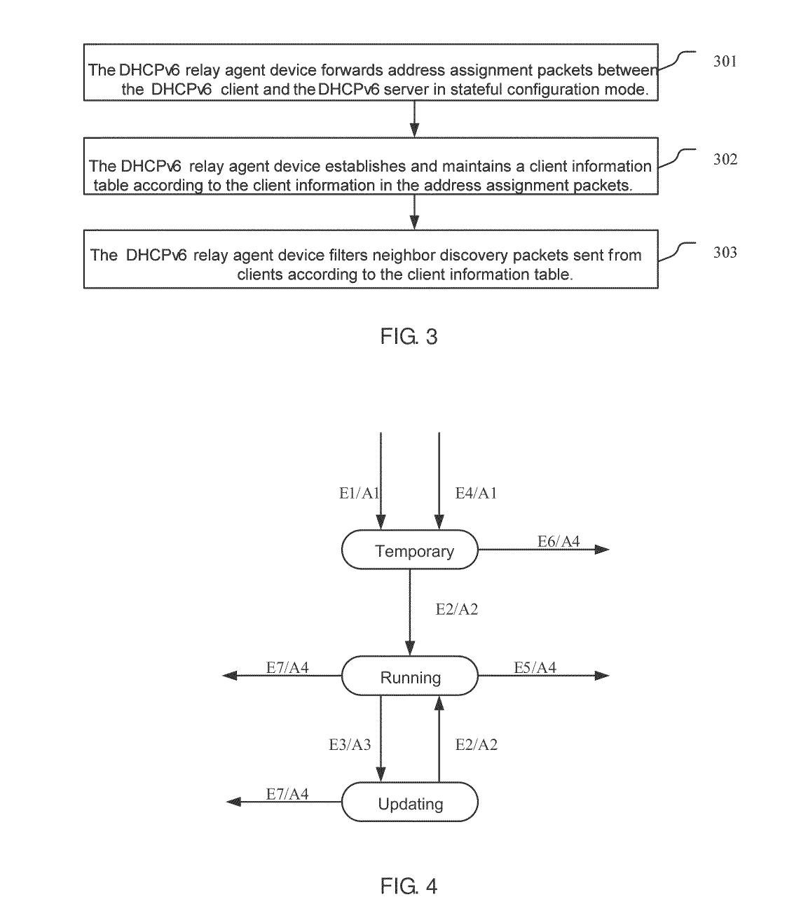

FIG. 3 is a flow chart illustrating how an embodiment of the present invention prevents spoofed packet attacks. This method is applicable to a network where the client contacts the DHCPv6 server via a DHCPv6 relay agent device, such as the network in FIG. 1. As shown in FIG. 3, the method comprises these steps:

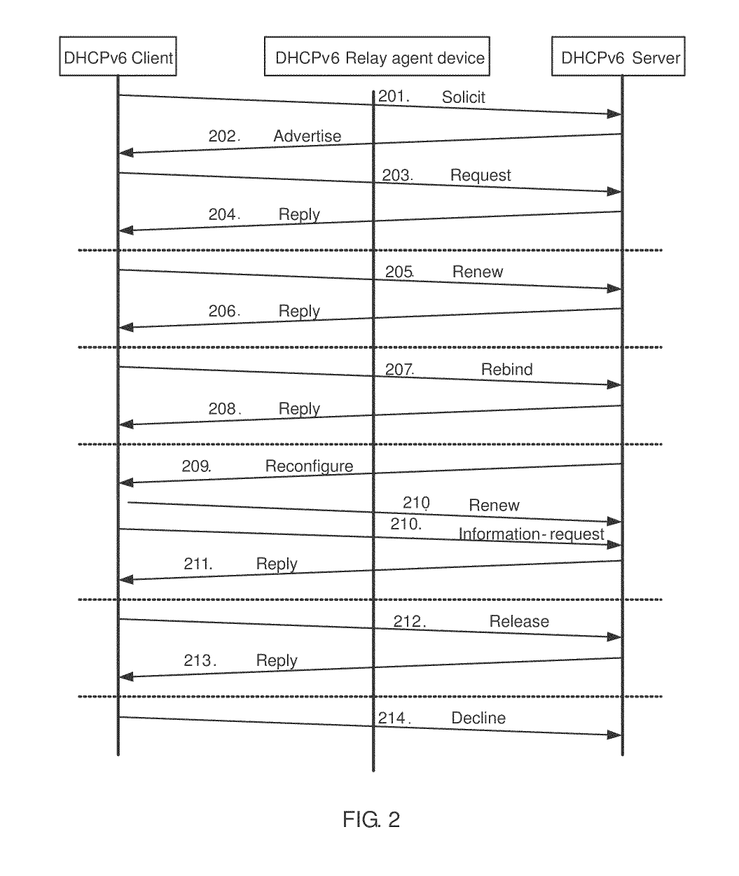

At step 301, the DHCPv6 relay agent device forwards the address assignment packets between the client and the DHCPv6 server in stateful configuration mode. Wherein, the address assignment packets are sent as shown in FIG. 2.

At step 302, the DHCPv6 relay agent device establishes and maintains a client information table according to the client information in the address assignment packets.

At step 303, the DHCPv6 relay agent device filters ND packets from clients according to the client information table.

For a better understanding of the objectives, technical solution and advantages of the present invention, the following describes how the DHCPv6 relay agent creates and maintains the client information table according to the address assignment packets.

1. Content of Client Information Table

Table 2 shows the client information table in an embodiment of the present invention:

TABLE 2

| IP | Client | Access | | Entry |
|---|---|---|---|---|
| address | ID | point | Lease | state |
| IP 1 | ID 1 | Interface 1 | Lease 1 | Temporary |
| IP 2 | ID 2 | Interface 2 | Lease 2 | Running |
| IP 3 | ID 3 | Interface 3 | Lease 3 | Updating |
| . . . | . . . | . . . | . . . | . . . |

As shown in table 2, each entry of the client information table comprises: IP address, client ID, access point, lease, and entry state. The entry state can be temporary, running, or updating. In the following embodiments of the present invention, the client ID comprises: client link address and transaction ID.

2. Request Message

When the DHCPv6 relay agent device receives a Request message from a client, it looks up the client information table for an entry with the same client ID as that in the message. Herein, the client ID of the embodiment comprises: client link address and transaction ID. If no matching entry is found, the DHCPv6 relay agent device uses the client link address, transaction ID, and access point that received the message to create an entry in the client information table and sets the entry state as temporary, as shown in table 3.

TABLE 3

| IP | Link | Transaction | Access | | Entry |
|---|---|---|---|---|---|
| address | address | ID | point | Lease | state |
| xxx | 1-1-1 | 123456 | Interface 1 | xxx | Temporary |

As shown in table 3, the link address of the Request message is 1-1-1, the transaction ID is 123456, the access point is interface 1, and the entry state is temporary. Now, the client IP address and lease are not available.

If a matching entry is found, the DHCPv6 relay agent device does not create a new entry but processes the Request message normally.

3. Reply Message of the Request Message

Upon receiving from the DHCPv6 server the Reply message in response to the Request message, the DHCPv6 looks up the client information table for an entry that has the same client link address and transaction ID as the Reply message and is in temporary state. If the matching entry is found, the DHCPv6 relay agent device changes the entry state to running, and adds the client IP address and lease information in the Reply message into the entry. If the matching entry is as shown in table 3, it is changed to that as shown in table 4.

TABLE 4

| IP | Link | Transaction | Access | | Entry |
|---|---|---|---|---|---|
| address | address | ID | point | Lease | state |
| 1::1 | 1-1-1 | 123456 | Interface 1 | 7 days | Running |

As shown in table 4, the client IP address is 1::1 and the lease is 7 days in the Reply message. The DHCPv6 relay agent device starts the 7-day lease timer.

4. Renew/Rebind Messages

Upon receiving a Renew message from a client, the DHCPv6 relay agent device looks up the client information table for an entry that has the same client IP address, client link address, and transaction ID as the message and is in running state. If a match is found, the DHCPv6 changes the entry state to updating. If the matching entry is as shown in table 4, it is changed to that as shown in table 5.

TABLE 5

| IP | Link | Transaction | Access | | Entry |
|---|---|---|---|---|---|
| address | address | ID | point | Lease | state |
| 1::1 | 1-1-1 | 123456 | Interface 1 | 7 days | Updating |

Upon receiving a Rebind message from a client, the DHCPv6 relay agent device does the same as it does upon receiving a Renew message.

5. Reply Message of Renew/Rebind Message

Upon receiving from the DHCPv6 server a Reply message in response to a Renew/Rebind message, the DHCPv6 relay agent device looks up the client information table for an entry that has the same client IP address, client link address, and transaction ID as the Reply message and is in updating state. If the entry is found, the DHCPv6 relay agent device changes the entry state to running, and updates the lease in the entry according to that in the Reply message. If the entry found is as shown in table 5, it is changed to that as shown in table 6.

TABLE 6

| IP | Link | Transaction | Access | | Entry |
|---|---|---|---|---|---|
| address | address | ID | point | Lease | state |
| 1::1 | 1-1-1 | 123456 | Interface 1 | 8 days | Running |

As shown in Table 6, the lease in the Reply message is 8 days. The DHCPv6 relay agent device removes the previous lease timer, and starts a new 8-day lease timer.

6. Release/Decline Messages

Upon receiving a Release/Decline message from a client, the DHCPv6 relay agent device looks up the client information table for an entry with the same client IP address, client link address and transaction ID as the message. If the entry is found, it removes the entry. If the found entry is as shown in Table 6, the DHCPv6 relay agent device removes the entry.

7. Entry Removal Upon Lease Expiration

The DHCPv6 relay agent device removes an entry whose lease expires. Take the entry in table 6 for example. When the 8-day lease timer expires, the DHCPv6 relay agent device removes the entry.

Solicit messages and corresponding reply messages carrying rapid commit options are also used to establish and maintain the client information table.

8. Solicit Message Carrying a Rapid Commit Option

Upon receiving a solicit message carrying a rapid commit option from a client, the DHCPv6 relay agent device looks up the client information table for an entry with the same client link address and transaction ID as the message. If no matching entry is found, the DHCPv6 relay agent device creates an entry containing the client link address, transaction ID and the receiving access point in the client information table and sets the entry state as temporary, such as the entry in table 3.

9. Reply Message Carrying a Rapid Commit Option

Upon receiving from the DHCPv6 server a Reply message carrying a rapid commit option and client ID, the DHCPv6 relay agent looks up the client information table for a match. If an entry with the same client ID in temporary state is found, the DHCPv6 relay agent changes the entry state to running, and adds the client IP address and lease information in the Reply message into the entry, such as the entry in table 4.

10. Temporary Entry Timer Expiration

The DHCPv6 relay agent device sets a timer for each client information entry that is in temporary state. If the entry state is not changed to running state before the timer expires, the DHCPv6 relay agent device removes the entry. The timer is set to 60 seconds in this embodiment of the present invention.

To show more clearly how the entry state changes in the above mentioned client information table, an embodiment of the present invention gives the corresponding state transition diagram, as shown in FIG. 4.

As shown in FIG. 4, E refers to a state transition event, and A refers to a state transition action. Table 7 demonstrates the sequence of state transition events, and table 8 demonstrates the sequence of state transition actions.

TABLE 7

| Event | |
|---|---|
| number | Description |
| E1 | Receive a Request message from the client, |
| | and no matching entry exists in the client |
| | information table. |
| E2 | Receive the Reply message from the DHCPv6 |
| | server. |
| E3 | Receive a Renew/Rebind message from the |
| | client. |
| E4 | Receive a Solicit message carrying a rapid |
| | commit option from the client, and no |
| | matching entry exists in the client |
| | information table. |
| E5 | Receive a Release/Decline message from the |
| | client. |
| E6 | The 60-second timer T1 expires. |
| E7 | T2 expires. T2 is the lease timer of the |
| | client IP address. |

TABLE 8

| Action | |
|---|---|
| number | Description |
| A1 | Create an entry with its state set as |
| | temporary. |
| A2 | The entry state changes to running state. |
| A3 | The entry state changes to updating state. |
| A4 | Remove the entry. |

Based on the client information table, the DHCPv6 relay agent device can filter out incoming spoofed ND packets. The detailed operations are as follows: Upon receiving an ND packet from a client, the DHCPv6 relay agent device looks up the client information table for an entry with the same client IP address, client ID and access point as the ND packet. If no matching entry is found, the DHCPv6 relay agent device drops the ND packet. If a matching entry is found but in temporary state, the DHCPv6 relay agent device drops the ND packet; otherwise, the DHCPv6 relay agent device processes the packet normally.

This method can at least prevent the spoofed ND packet attacks in the following cases.

Case 1: Spoofed NS/NA Attack

In the network of FIG. 1, client 1 masquerades as client 2 to send NS/NA messages, in attempt to change the ND entry of client 2 such as the MAC address on the DHCPv6 relay agent device. If the DHCPv6 relay agent device has established the client information table that records the information of client 2 based on the proposal of the present invention, it can filter the spoofed NS/NA messages.

Case 2: Spoofed RS Attack to Gateway

In the network of FIG. 1, client 1 masquerades as client 2 to send NS/NA messages, in attempt to change the ND entry of client 2 such as the MAC address on the DHCPv6 relay agent device, which serves as a gateway. If the DHCPv6 relay agent device has established the client information table that records the information of client 2 based on the proposal of the present invention, it can filter the spoofed NS/NA messages.

Case 3: Snooped Redirect Attack to Hosts

In the network of FIG. 1, client 1 masquerades as the DHCPv6 relay agent device that serves as the gateway to send a redirect message to client 2 and thus to change the corresponding ND entry on client 2. It also intercepts the message sent from client 2 to the DHCPv6 relay agent device. Besides, client 1 sends an RA message to the DHCPv6 relay agent device, in attempt to change the ND entry of client 2 such as the MAC address on the DHCPv6 relay agent device. If the entry is changed, the packets that the DHCPv6 relay agent device intends to send to client 2 are actually sent to client 1. If the DHCPv6 relay agent device has established the client information table that records the information of client 2 based on the proposal of the present invention, it can filter such spoofed RA messages to avoid the above mentioned situation.

Case 4: Illegal Clients Access Attack

In the network of FIG. 1, client 1 has an IP address manually configured rather than through DHCP and then wants to get online through the DHCPv6 relay agent device, which serves as the gateway. If the DHCPv6 relay agent device has established the client information table that records the information of all legal clients based on the proposal of the present invention, it can filter the request of client 1.

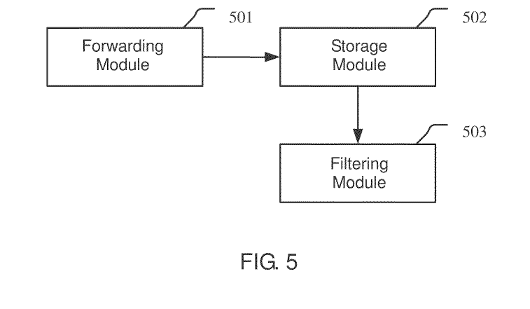

Based on the above embodiment, the present invention provides the structure of the DHCPv6 relay agent device, as shown in FIG. 5.

The DHCPv6 relay agent device comprises forwarding module 501, storage module 502, and filtering module 503.

Forwarding module 501 is used to forward address assignment packets between the client and the DHCPv6 server in stateful configuration mode, and establish and maintain a client information table according to the client information in the forwarded address assignment packets. Storage module 502 is used to store the client information table.

Filtering module 503 is used to filter clients' ND packets according to the client information table. In FIG. 5, the address assignment packets forwarded by forwarding module 501 comprise request, renew, rebind, reply, release, and decline messages. Each entry in the client information table established by forwarding module 501 comprises an IP address, client ID, access point, lease and entry state. The entry state can be temporary, running, or updating.

Forwarding module 501, upon receiving a Request message carrying a client ID from a client, looks up the client information table for an entry with the same client ID, and if no matching entry is found, creates an entry containing the client ID and the receiving access point and sets its state as temporary.

Forwarding module 501, upon receiving from the DHCPv6 server a Reply message in response to a Request message, looks up the client information table for an entry that has the same client ID as the Reply message and is in temporary state. If the entry is found, it changes the entry state to running, and adds the client IP address and lease information in the Reply message into the entry.

Forwarding module 501, upon receiving a Renew/Rebind message from a client, looks up the client information table for an entry that has the same client IP address and client ID as the message and is in running state. If the entry is found, it changes the entry state to updating.

Forwarding module 501, upon receiving a Reply message in response to a Renew/Rebind message from the DHCPv6 server, looks up the client information table for an entry that has the same client ID and client IP address as the Reply message and is in updating state. If the entry is found, it changes the entry state to running, and updates the lease in the entry according to that in the Reply message.

Forwarding module 501, upon receiving a Release/Decline message from a client, looks up the client information table for an entry with the same client IP address and client ID as the message. If the entry is found, it removes the entry.

Forwarding module 501 removes entries whose lease expires from the client information table.

In FIG. 5, the address assignment packets forwarded by forwarding module 501 further comprise: solicit message carrying a rapid commit option, and reply message carrying a rapid commit option in response to the solicit message.

Forwarding module 501, upon receiving a solicit message carrying a rapid commit option and a client ID from a client, looks up the client information table for an entry with the same client ID. If no matching entry is found, forwarding module 501 creates an entry containing the client ID and the receiving access point and sets its state as temporary.

Forwarding module 501, upon receiving a Reply message carrying a rapid commit option and client ID from the DHCPv6 server, looks up the client information table for a match. If an entry with the same client ID in temporary state is found, forwarding module 501 changes the entry state to running, and adds the client IP address and lease information in the Reply message into the entry.

In FIG. 5, the client ID in the client information table that forwarding module 501 creates comprises: client link address and transaction ID.

In FIG. 5, filtering module 503, upon receiving an ND packet from a client, looks up the client information table for a match according to the source IP address and client ID in the ND packet and the receiving access point. If no matching entry is found, filtering module 503 drops the ND packet. If a matching entry in temporary state is found, it also drops the ND packet. Otherwise, filtering module 503 processes the ND packet normally.

In summary, the DHCPv6 relay agent device in the present invention forwards the address assignment packets between the client and the DHCPv6 server in stateful configuration mode, establishes and maintains a client information table according to the forwarded address assignment packets, and filters clients' ND packets according to the client information table, and thus prevents the attacks of spoofed ND packets.

Although a preferable embodiment of the present invention and its advantages are described in detail, a person skilled in the art could make various alternations, additions, and omissions without departing from the spirit and scope of the present invention as defined by the appended claims.

What is claimed is:

1. A method for preventing spoofed packet attacks in a network including a DHCP relay agent device, a plurality of client devices, and a DHCP server, the method comprising:
the DHCP relay agent device forwarding address assignment packets between the clients and the DHCP server;
the DHCP relay agent device establishing and maintaining a client information table comprising client information obtained from the address assignment packets; and
the DHCP relay agent device filtering neighbour discovery (ND) packets sent from the clients in accordance with a current state of the client information table.

2. The method of claim 1, wherein:
the address assignment packets comprise at least one selected from the group consisting of: request, renew, rebind, reply, release and decline messages;
each entry in the client information table is associated with a particular one of the clients and comprises: an IP address, a client ID, an access point identifier, a lease time, and an entry state, where the entry state reflects one of temporary, running, or updating;
the DHCP relay agent device establishing and maintaining the client information table comprises:
responsive to receiving a request message from a particular client device, looking in the client information table for a corresponding entry with a same client ID as the message, and if no corresponding entry is found, creating a new entry containing the client ID and the receiving access point and setting the new entry's state to temporary.

3. The method of claim 2, wherein the DHCP relay agent device establishing and maintaining the client information table further comprises:
determining an amount of time that the new entry has retained a state of temporary;
responsive to determining that the amount of time is greater than a predetermined threshold amount of time, removing the new entry from the client information table.

4. The method of claim 2, wherein the DHCP relay agent device establishing and maintaining the client information table further comprises:
responsive to receiving from the DHCP server a reply message in response to the request message, the DHCP relay agent looking in the client information table for a corresponding entry that has the same client ID as the reply message and has its state set as temporary, and responsive to finding the corresponding entry, changing the corresponding entry's state to running and adding the client IP address and lease information included in the reply message to the corresponding entry.

5. The method of claim 4, wherein the DHCP relay agent device establishing and maintaining the client information table further comprises:
determining, from the lease information included in the corresponding entry, that the particular client device's lease has expired; and
responsive to determining that the particular client device's lease has expired, removing the corresponding entry from the client information table.

6. The method of claim 4, wherein the DHCP relay agent device establishing and maintaining the client information table further comprises:
responsive to receiving a renew or rebind message from the client, the DHCP relay agent looking in the client information table for a corresponding entry that has the same client IP address and client ID as the message and is in a running state, and responsive to finding the corresponding entry, changing the corresponding entry's state to updating.

7. The method of claim 6, wherein the DHCP relay agent device establishing and maintaining the client information table further comprises:
responsive to receiving a reply message in response to the renew or rebind message from the DHCP server, the DHCP relay agent looking in the client information table for a corresponding entry that has the same client ID and client IP address as the reply message and is in the updating state, and responsive to finding the corresponding entry, changing the corresponding entry's state to running and updating the lease in the entry according to the reply message.

8. The method of claim 4, wherein the DHCP relay agent device establishing and maintaining the client information table further comprises:
responsive to receiving a release or decline message from the client, the DHCP relay agent looking in the client information table for a corresponding entry with the same client IP address and client ID as the message, and responsive to finding the corresponding entry, removing the corresponding entry.

9. The method of claim 2, wherein the address assignment packets further comprise: a solicit message carrying a rapid commit option and reply message carrying a rapid commit option in response to the solicit message; and
wherein the method further comprises:
responsive to receiving a solicit message carrying a rapid commit option and a client ID from a particular client device, the DHCP relay agent looking in the client information table for a corresponding entry with the same client ID and, responsive to finding no corresponding entry, the DHCP relay agent creating a new entry containing the client ID and the receiving access point and setting its state as temporary.

10. The method of claim 9, wherein the method further comprises:
responsive to receiving a reply message carrying a rapid commit option and client ID from the DHCP server, the DHCP relay agent looking in the client information table for a corresponding entry, and responsive to finding the corresponding entry with the same client ID and a state of temporary, the DHCP relay agent changing the corresponding entry's state to running and adding the client IP address and lease information in the reply message to the corresponding entry.

11. The method of claim 2, wherein the client ID comprises a client link address and a transaction ID.

12. The method of claim 2, wherein the DHCP relay agent filtering ND packets from a second particular client according to the client information table comprises:
responsive to receiving an ND packet from the second particular client, the DHCP relay agent looking in the client information table for a matching entry according to the source IP address and client ID in the ND packet and according to the receiving access point;
the DHCP relay agent dropping the ND packet if (i) a matching entry is not found or (ii) a matching entry is found but its state is set to temporary, and otherwise, the DHCP relay agent processing the ND packet normally.

13. A DHCP relay agent device comprising a forwarding module, a storage module, and a filtering module, wherein:
the forwarding module is configured to forward address assignment packets between client devices and a DHCP server, and to establish and maintain a client information table comprising client information obtained from the address assignment packets;
the storage module is configured to store the client information table; and
the filtering module is configured to filter neighbour discovery (ND) packets sent from the client devices in accordance with a current state of the client information table.

14. The DHCP relay agent device of claim 13, wherein the address assignment packets forwarded by the forwarding module comprise at least one selected from the group consisting of: request, renew, rebind, reply, release and decline messages;
wherein each entry in the client information table is associated with a particular one of the clients and comprises: a client IP address, a client ID, an access point identifier, a lease time, and an entry state, where the entry state reflects one of temporary, running, or updating; and
wherein the forwarding module is configured to, responsive to receiving a request message carrying a client ID from a particular client device, look in the client information table for a corresponding entry with the same client ID, and if no corresponding entry is found, create a new entry containing the client ID and the receiving access point and setting the new entry's state to temporary.

15. The DHCP relay agent device of claim 14, wherein the forwarding module is further configured to, responsive to receiving from the DHCP server a reply message in response to the request message, look in the client information table for a corresponding entry that has the same client ID as the reply message and has a state of temporary, and responsive to finding the corresponding entry, changing the corresponding entry's state to running and adding the client IP address and lease information in the reply message to the corresponding entry.

16. The DHCP relay agent device of claim 15, wherein the forwarding module is further configured to, responsive to receiving a renew or rebind message from the particular client device, look in the client information table for a corresponding entry that has the same client IP address and client ID as the message and has a state of running, and responsive to finding the corresponding entry, change the corresponding entry's state to updating.

17. The DHCP relay agent device of claim 16, wherein the forwarding module is further configured to, responsive to receiving a reply message in response to the renew or rebind message from the DHCP server, look in the client information table for a corresponding entry that has the same client ID and client IP address as the reply message and has a state of updating, and responsive to finding the corresponding entry, change the corresponding entry's state to running and update the lease in the corresponding entry according to that set forth in the reply message.

18. The DHCP relay agent device of claim 15, wherein the forwarding module is further configured to, responsive to receiving a release or decline message from the particular client device, look in the client information table for a corresponding entry with the same client IP address and client ID as the message, and responsive to finding the corresponding entry, remove the entry.

19. The DHCP relay agent device of claim 14, wherein the forwarding module is further configured to:
responsive to receiving a solicit message carrying a rapid commit option and a client ID from the particular client device, look in the client information table for a corresponding entry with the same client ID, and responsive to finding no corresponding entry, create a new entry containing the client ID and the receiving access point and set the new entry's state to temporary; and
responsive to receiving a reply message carrying a rapid commit option and client ID from the DHCP server, look in the client information table for a corresponding entry, and responsive to finding a corresponding entry with the same client ID and a state of temporary, the change the corresponding entry's state to running and add the client IP address and lease information in the reply message to the corresponding entry.

20. The DHCP relay agent device of claim 14, wherein the filtering module is configured to, responsive to receiving a ND packet from a second particular client device, look up the client information table for a match according to the source IP address and client ID in the ND packet and the receiving access point, and
wherein the filtering module is further configured to drop the ND packet if (i) a matching entry is not found or (ii) a matching entry is found but its state is set to temporary, and otherwise, the filtering module processes the ND packet normally.
